(19) United States
(12) Patent Application Publication
(10) Pub. No.: US 2004/0170811 A1
(43) Pub. Date: Sep. 2, 2004

(54) Method of creating a plastic mold edge for a piece of furniture

(76) Inventors: Andrew Leland Malin, Colorado Springs, CO (US); Leon Gray JR., Muldrow, OK (US)

Correspondence Address: Law Office of Dale B. Halling, LLC, Suite 311, 24 S. Weber St., Colorado Springs, CO, 80903, US

(21) Appl. No.: 10/703,899

(22) Filed: Nov. 7, 2003

Related U.S. Application Data
(63) Continuation of application No. 09/398,565, filed on Sep. 16, 1999, now abandoned.

(51) Int. Cl. B32B 23/02

(52) U.S. Cl. 428/192

(57) ABSTRACT

A method of creating a plastic mold edge for a piece of furniture includes the steps of extruding a bar of plastic. A surface of the bar of plastic is then planed. A methyl ethyl ketone solution is then placed on the surface of the bar of plastic. Next, a high temperature glue is applied to the surface of the bar of plastic. The surface is then pressed against a piece of wood. Routers then shape the bar of plastic into an ornamental shape.

### FIELD OF THE INVENTION

The present invention relates generally to the field of furniture and more particularly to a method of creating a plastic mold edge for a piece of furniture.

### BACKGROUND OF THE INVENTION

In the commercial furniture market, such as hotels, it is important that the furniture be rugged and stylish. Patrons of hotels are not necessarily concerned if they bump the furniture with their luggage or leave glasses of water on the furniture. Thus there has been a need for very rugged, yet stylish furniture. Flat surfaces, such as wood table tops, can have, extra coats of polyurethane. Another solution for table tops is to use a laminated plastic surface (e.g., Formica®) that is rugged and impervious to water. Unfortunately, the edges or sides of the furniture are most likely to become scratched or dented. Extra layers of polyurethane do not help much with these problems. Manufacturers have used the laminated plastic surfaces (or plastic bumpers) on the edges and they provide reasonable protection. However, these plastic surfaces have a tendency to become unglued. In addition, these surfaces must be flat to have the plastic surface adhere to the underlying wood. This does not accommodate many styles of furniture.

Thus there exists a need for a furniture edging material that is rugged, stylish and can be shaped.

### BRIEF DESCRIPTION OF THE DRAWINGS

FIG. 1 is a schematic diagram of the steps used in a method of creating a plastic mold edge for a piece of furniture in accordance with one embodiment of the invention;

FIG. 2 is a perspective view of a saw blade in accordance with one embodiment of the invention;

FIG. 3 is a flow chart of the steps used in a method of creating a plastic mold edge for a piece of furniture in accordance with one embodiment of the invention;

FIG. 4 is a flow chart of the steps used in a method of creating a plastic mold edge for a piece of furniture in accordance with one embodiment of the invention; and

FIG. 5 is a flow chart of the steps used in a method of creating a plastic mold edge for a piece of furniture in accordance with one embodiment of the invention.

### DETAILED DESCRIPTION OF THE DRAWINGS

The invention provides a method of creating a plastic mold edge for a piece of furniture that is both rugged and stylish. The first step is to extrude a bar of plastic. A surface of the bar of plastic is then planed. A methyl ethyl ketone solution is then placed on the surface of the bar of plastic. Next, a high temperature glue is applied to the surface of the bar of plastic. The surface is then pressed against a piece of wood. Routers then shape the bar of plastic into an ornamental shape. The longevity of the tools can be enhanced by venting the tools. The shaped plastic bar is stylish and provides a very sturdy scratch resistant surface on the edge of the furniture.

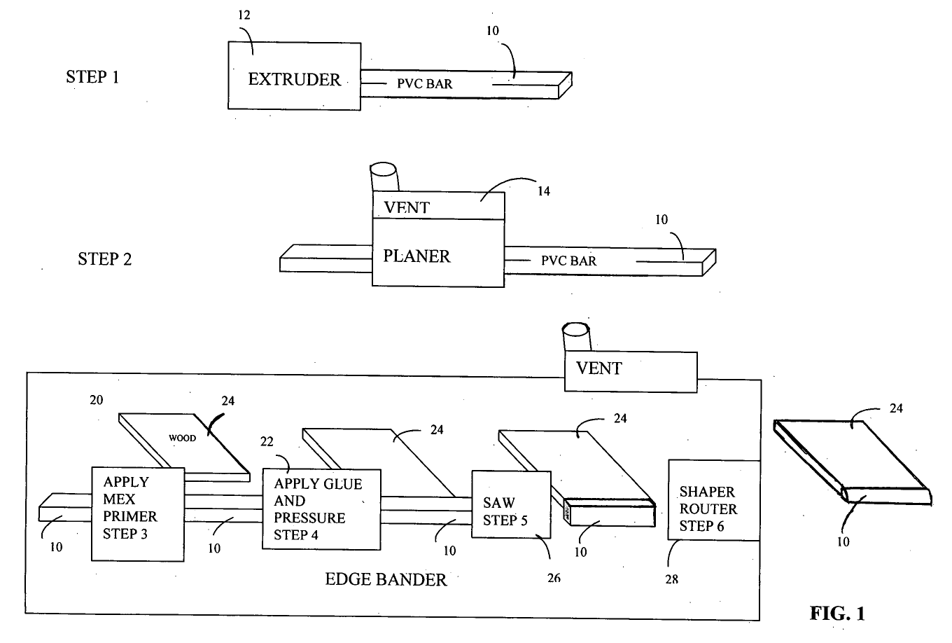

FIG. 1 is a schematic diagram of the steps used in a method of creating a plastic mold edge for a piece of furniture in accordance with one embodiment of the invention. The first step in the process is to extrude a bar of plastic 10 using an extruder 12. In one embodiment, the bar of plastic is made of polyvinyl chloride (PVC). In another embodiment, the bar of plastic is a one inch by one inch bar. The second step is to plane a surface of the bar of plastic 10 using a planer 14. In one embodiment the planer 14 is vented using a vent 16. A reason for venting the planer is that cutting PVC gives off chlorine gas and chlorine gas has a tendency to rust tools very quickly. In another embodiment, the planer 14 planes two surfaces of the bar of plastic 10. A reason for planing the bar of plastic is that PVC has a tendency to deform as it cools. As a result, the surface of the bar of plastic in larger volumes has a tendency to not be completely flat. Steps 3-6 are performed by an edgebander 16, in one embodiment. A standard edgebander 16 is modified to include a vent 18, in one embodiment. The third step is to apply a methyl ethyl ketone solution 20 to the surface of the bar of plastic 10. Unlike wood, plastic has almost no pores as a result the surface has to be roughed up to adhere well when glued to wood. In one embodiment, the methyl ethyl ketone (MEK) solution is mixed with a standard plastic primer. In one embodiment, the solution is 50% MEK and 50% plastic primer. The primer improves the performance of the glue. The fourth step 22 applies glue and pressure. The glue is applied to the surface of the bar of plastic 10 (or to the edge of a piece of wood 24). The bar of plastic 10 is then pressed against the piece of wood 24. In one embodiment, the pressure used to push the piece of wood 24 against the bar of plastic is set as high as the edgebander allows. In one embodiment the pressure rollers include a large (approximately 7 inch diameter) flat roller and two smaller rollers having opposite slopping surfaces of about 2.5 degrees. In one embodiment the wood is particle board. In one embodiment, the edgebander is a Holzer, Triathlon 480. In one embodiment the glue is a hot melt glue. In another embodiment, the glue is selected to not set extremely hard, in other words the glue is a soft glue. The soft glue is pliable when set (cured) and this allows for thermal expansion differences between the wood and the bar of plastic. An example of such a glue is Jowatherm Glue No. 288-53 from Jowat Corporation of North Carolina. This glue also has a high release temperature of around 204 degrees Fahrenheit. This prevents the molding from becoming loose when the furniture is in the hot sun. In one embodiment the glue is UV (ultraviolet) resistant.

The fifth step 26 is trimming the bar of plastic 10 to the edges of the piece of wood 24. A saw (saws) 26 are used to trim the bar of plastic 10. The blades on the saw 26 are modified to have an alternate top bevel grind with around a ten degree positive rake. The standard saws chattered when cutting through the bar of plastic. This resulted in chipped, rough finish. The inventors believe that standard saws had too large of a bite and this was what caused the chatter. The sixth step 28 is shaping the bar of plastic 10 to provide a stylish finish. In one embodiment, a router bit used to shape the bar of plastic has at least four cutting surfaces and as many as six or more cutting surfaces. In addition, the number of router bits was increased from three to six in one embodiment. The reasons for these changes is that the edgebander as originally designed resulted in chatter and rough finishes. In one embodiment when the finish is not as smooth as desired, the shaped bar of plastic is rubbed with MEK or steel wool. The wood with the plastic mold edge is now ready for use in a piece of furniture.

In one embodiment, the edgebander 16 is modified to have a slower feed rate than the factory settings. The slower feed rate is necessary to allow the glue time to set and to reduce the cutting rate of the saws and routers. This increases the life of the saw blades and router bits and decrease the chances of chatter. One likely reason for the problem with the chatter is that PVC plastic is considerably more dense than wood. The lowest factory set feed rate, in one embodiment, is 8000 mm/minute. In one embodiment, the feed rate is set to 6000 mm/minute.

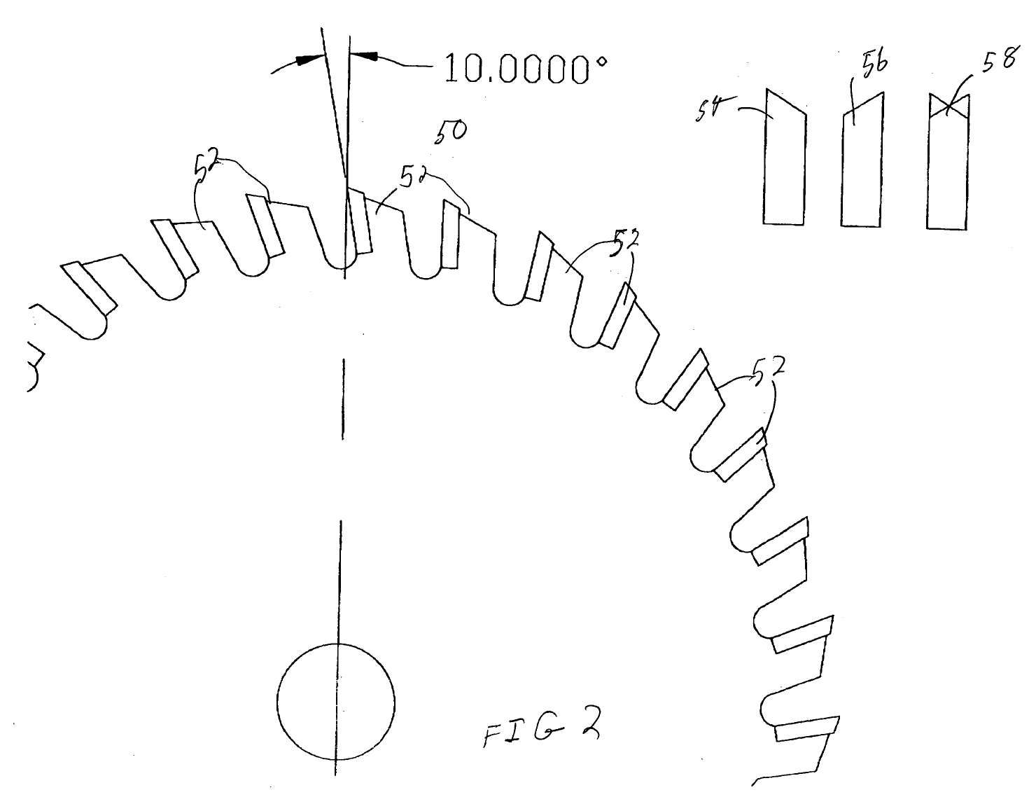

FIG. 2 is a perspective view of a saw blade 50 in accordance with one embodiment of the invention. The saw blade 50 has a plurality of teeth 52. Each tooth 52 has a ten degree positive rake. The teeth 52 also have an alternate top bevel design. A first tooth 54 is shown schematically looking straight onto the tooth's front face (cutting face). Note the first tooth 54 has a left sloping bevel. The second tooth 56 has a right sloping bevel. The first and second tooth alternate along the saw blade 50 providing a look like 58.

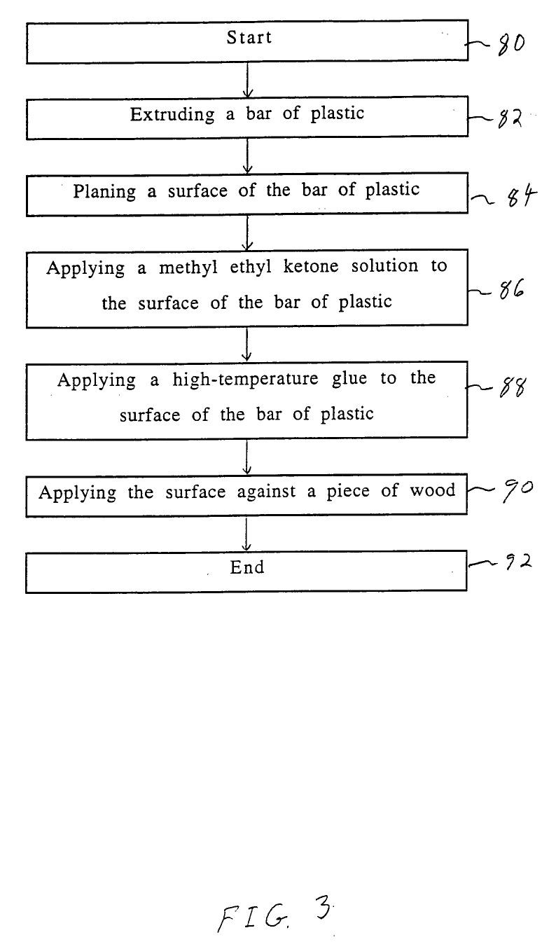

FIG. 3 is a flow chart of the steps used in a method of creating a plastic mold edge for a piece of furniture in accordance with one embodiment of the invention. The process starts, step 80, by extruding a bar of plastic at step 82. A surface of the bar of plastic is planed at step 84. A methyl ethyl ketone (MEK) solution is applied to the surface of the bar of plastic at step 86. A high-temperature glue is applied to the surface of the bar of plastic at step 88. High-temperature glue as used herein means a glue that has a high release temperature, around 200 degrees Fahrenheit. At step 90, the surface is applied against a piece of wood which ends the process at step 92. In one embodiment the bar of plastic is a polyvinyl chloride plastic. In another embodiment, the bar of plastic is planed to flatness of around 0.127 millimeters (0.005 inches). In another embodiment the MEK is mixed with a plastic primer and then applied to the plastic. The glue in one embodiment is a soft glue that is applied in a layer of about 0.254 millimeters (0.01 inches). A soft glue as used herein means a glue that pliable upon curing as opposed to hard and brittle.

In one embodiment the bar of plastic is trimmed to the length of the piece of wood after the bonding step. The bar of plastic is shaped to form an ornamental design. In one embodiment a router is used to shape the bar of plastic. The router bit has at least four blades in one embodiment of the invention.

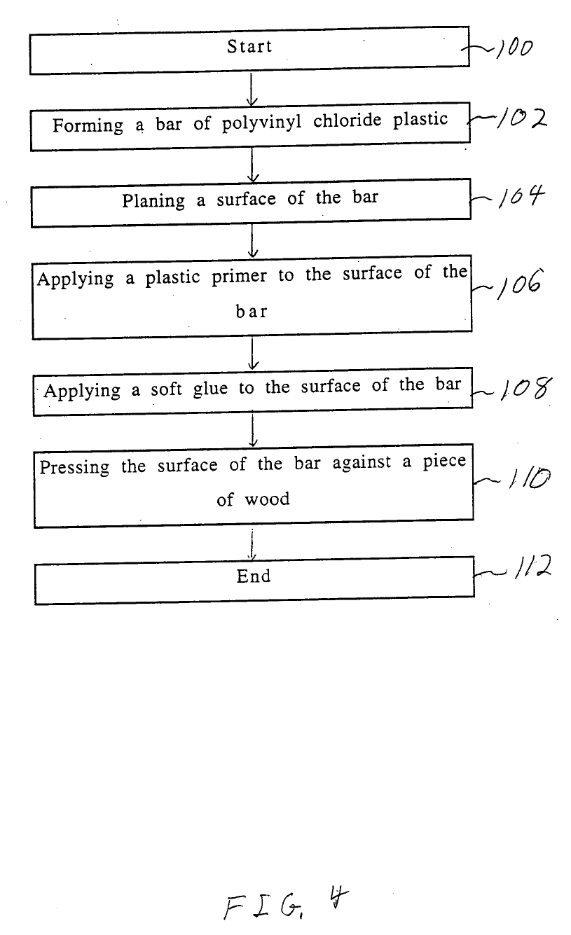

FIG. 4 is a flow chart of the steps used in a method of creating a plastic mold edge for a piece of furniture in accordance with one embodiment of the invention. The process starts, step 100, by forming a bar of polyvinyl chloride plastic at step 102. A surface of the bar is planed at step 104. A plastic primer is applied to the surface of the bar at step 106. A soft glue is applied to the surface of the bar at step 108. At step 110, the surface is pressed against a piece of wood which ends the process at step 112. In one embodiment, the bar is then trimmed at a pair of edges of the piece of wood. The bar of plastic is then shaped. In one embodiment, the saw blade used for trimming the bar of plastic has an alternate top bevel grind. The teeth of the saw blade have a positive rake of about ten degrees.

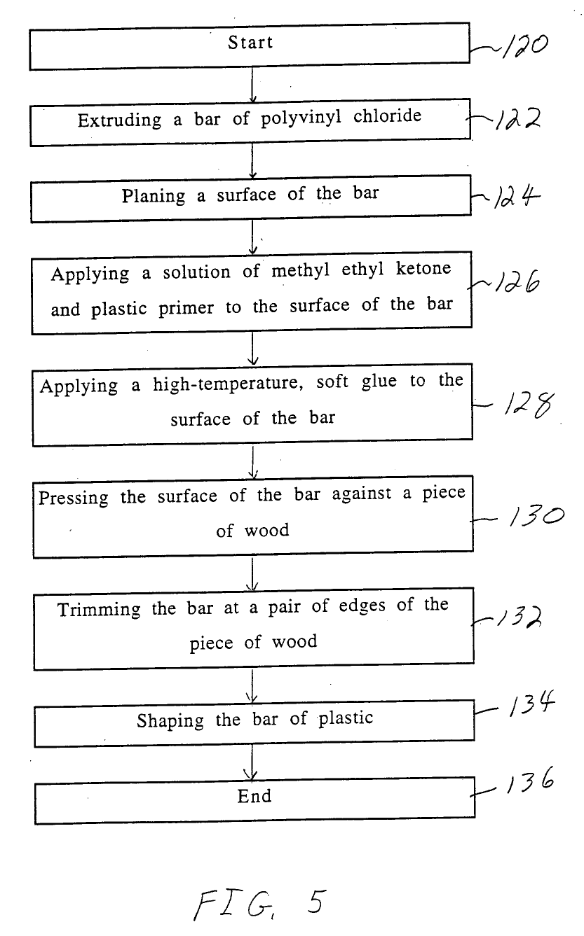

FIG. 5 is a flow chart of the steps used in a method of creating a plastic mold edge for a piece of furniture in accordance with one embodiment of the invention. The process starts, step 120, by extruding a bar of polyvinyl chloride at step 122. A surface of the bar is planed at step 124. A solution of methyl ethyl ketone and plastic primer is applied to the surface of the bar at step 126. A high-temperature, soft glue is applied to the surface of the bar at step 128. The surface of the bar is pressed against a piece of wood at step 130. The bar is trimmed at a pair of edges of the piece of wood at step 132. At step 134 the bar of plastic is shaped which ends the process at step 126.

Thus there has been described a method of forming a plastic edge for a piece of furniture that is both rugged and stylish. While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A method of creating a plastic mold edge for a piece of furniture, comprising the steps of:
(a) extruding a bar of plastic;
(b) planing a surface of the bar of plastic;
(c) applying a methyl ethyl ketone solution to the surface of the bar of plastic;
(d) applying a high-temperature glue to the surface of the bar of plastic; and
(e) applying the surface against a piece of wood.

2. The method of claim 1, wherein step (a) includes the step of selecting a polyvinyl chloride plastic.

3. The method of claim 1, wherein step (b) includes setting a planing process to provide a flatness of around 0.127 millimeters.

4. The method of claim 1, wherein step (c) further includes the step of mixing the methyl ethyl ketone with a plastic primer.

5. The method of claim 1, wherein step (d) includes the step of selecting a soft glue.

6. The method of claim 1, wherein step (b) further includes venting a planer.

7. The method of claim 1, further including the steps of:
(e) trimming the bar of plastic at both ends of the piece of wood;
(f) shaping the bar of plastic.

8. The method of claim 7, wherein step (e) further includes the step of venting a saw used for trimming.

9. The method of claim 7, wherein step (f) further includes the step of venting a router used for shaping.

10. The method of claim 9, wherein the router has at least four knife edges.

11. A method of creating a plastic mold edge for a piece of furniture using an edgebander, comprising the steps of:
(a) forming a bar of polyvinyl chloride plastic;
(b) planing a surface of the bar;
(c) applying a plastic primer to the surface of the bar;
(d) applying a soft glue to the surface of the bar; and
(e) pressing the surface of the bar against a piece of wood.

12. The method of claim 11, further including the steps of:
(f) trimming the bar at a pair of edges of the piece of wood;
(g) shaping the bar of plastic.

13. The method of claim 11, wherein step (a) further includes the steps of:
(a1) venting the edgebander;
(a2) setting the edgebander for a feed rate below 8,000 millimeters per minute.

14. The method of claim 11, wherein step (b) further includes the step of venting a planer.

15. The method of claim 11, wherein step (c) further includes the step of applying a methyl ethyl ketone solution to the surface of the bar.

16. The method of claim 12, wherein step (f) further includes the step of selecting a saw having an alternate top bevel grind.

17. The method of claim 16, further including the step of selecting a saw having teeth with around a ten degree positive rake.

18. A method of creating a plastic mold edge for a piece of furniture, comprising the steps of:
(a) extruding a bar of polyvinyl chloride;
(b) planing a surface of the bar;
(c) applying a solution of methyl ethyl ketone and plastic primer to the surface of the bar;
(d) applying a high-temperature, soft glue to the surface of the bar;
(e) pressing the surface of the bar against a piece of wood;
(f) trimming the bar at a pair of edges of the piece of wood; and
(g) shaping the bar of plastic.

19. The method of claim 18, wherein step (b) further includes the step of venting a planer.

20. The method of claim 18, wherein step (g) further includes the step of venting an edgebander.

21. The method of claim 18, wherein step (g) further includes the step of selecting a router having at least four cutting edges.
